(19) United States
(12) Patent Application Publication
(10) Pub. No.: US 2013/0020382 A1
(43) Pub. Date: Jan. 24, 2013

(54) PAPERBOARD ACCORDION PACKAGE

(71) Applicants: Charlotte Hanks, Richmond, VA (US); Sara Jane Falcon, Richmond, VA (US)

(72) Inventors: Charlotte Hanks, Richmond, VA (US); Sara Jane Falcon, Richmond, VA (US)

(73) Assignee: MeadWestvaco Corporation, Richmond, VA (US)

(21) Appl. No.: 13/548,303

(22) Filed: Jul. 13, 2012

Related U.S. Application Data
(60) Provisional application No. 61/509,059, filed on Jul. 18, 2011.

(51) Int. Cl. B65D 5/355; B31B 17/26

(52) U.S. Cl. 229/101; 493/110

(57) ABSTRACT

A package is disclosed which includes connected front and back panels connected by a pleated or accordion side panels. The package may be opened by applying a flexing force to an opening end in order to break a separation line. After opening, the package may be reclosed by use of a closure flap or wing flaps that again hold the separation line together.

### REFERENCE TO RELATED APPLICATION

This application claims the benefit of priority under 35 U.S.C. §119(e) of U.S. provisional application Ser. No. 61/509,059 filed on Jul. 18, 2011, which is hereby incorporated by reference in its entirety.

### BACKGROUND

The invention consists of a folded carton structure with pleated or ‘accordion’ sides to provide an expandable internal volume. The package opening may be closed shut with an overlapping flap. The overlapping flap may cover the package opening after the package is opened.

The invention allows the user without the use of a tool to gain easy access into an expandable carton that is initially closed. The invention then allows the package to be placed into a reclosed configuration, with good appearance similar to an unopened package.

The present application is directed to paperboard packages and, more particularly, to easy-opening features for paperboard packages which after opening maintain a neat appearance.

Manufacturers and retailers of consumer goods, such as pharmaceuticals, software, electronics, health and beauty products and the like, typically package their products in tamper resistant security packages. For example, many consumer goods are packaged in blister or clamshell packages formed by positioning a consumer good in a flanged blister made from various polymeric and/or paperboard materials and sealing the flanged blister between two paperboard substrates. Consumers have voiced disapproval of such packages because of the difficulty of opening the same and the potential for being cut on a rough edge especially of plastic blisters. Packages may therefore be made based largely on paperboard, for example, NATRALOCK packages. Packaging made primarily of paperboard is more sustainable than packaging made from petroleum-based plastics. The paperboard used in such packages may be tear-resistant as described in commonly assigned U.S. Pat. No. 7,144,635.

Some packages may comprise a paperboard card and a polymeric blister. Other packages may not use a polymeric blister. In any case it would be advantageous to have a package that protects its contents well but is fairly easy to open.

The purpose of the invention is to provide a reclosable package wherein the same manufacturing can be used for a non-secure reclosable option or a secure fully sealed option. Providing both options allows manufacturers to choose the level of security desired for different retail settings without having to acquire two separate packaging solutions. This is especially necessary at a time when retailers are allowing consumers to “try out” their products in store before purchase. The reclosable option should provide easy access to the product, and maintain a clean appearance after opening to prevent deterring future purchase.

The package may include two panels sealed around a blister, where the back panel is folded in a z configuration on both sides, creating an accordion-like effect. Once the package is opened, the user may squeeze the sides of the accordion feature to create a pocket. This pocket allows the user to insert his or her hand into the package to assist in the removal of the product. It also provides room for the product to drop from the blister and slide out of the package.

The opening feature for the invention may differ depending on the level of security desired for the package. The opening feature for a reclosable package may include a perforation along the back card which can be broken by folding the top of the package forward. By breaking the perforation, the accordion pocket is freed on one end, allowing the user access to the product. The opening feature for a secure package may include a scissor cut line placed strategically on the package to allow the user access to the accordion pocket.

Reclosable tabs may be added to the package for a fully-reclosable design. These tabs can reclose the product at the center or the sides. Due to manufacturing considerations, the invention may be designed to work utilizing the properties of heat seal board. The package may be manufactured using a one-step or two-step sealing process. The one-step process may require a larger flange around the product to enable sealing of all sides of the package at once. The two-step sealing process may have a smaller footprint and may involve sealing the package sides first with the package in a non-flat state, followed by collapsing the package to a flat state and sealing of the top and bottom of the package.

### SUMMARY

In one aspect a package is disclosed which includes a front panel having a front top edge, and a front bottom edge, and a pair of front side edges, a back panel having a back top edge, a back bottom edge, and a pair of back side edges, the front panel and back panel together forming an enclosed volume with each of the back side edges connected through a respective expandable side wall connected to a corresponding front side edge, the back bottom edge connected to the front bottom edge, and the back top edge connected to the front top edge along an upper region above a closed perforation line across the back panel; wherein the upper region may be flexed forward relative to the back panel to break the closed perforation line and thereby open the enclosed volume.

In certain aspects the expandable side walls are formed by a z-fold in said back panel.

In certain aspects at least one of the panels includes a cover flap foldably attached to the top edge of the panel, and folded downward over the back panel so that the lower periphery of the cover flap extends at least partly beyond the perforation line.

In certain aspects, the cover flap is attached to the upper region of the back panel.

In certain aspects, after the enclosed volume has been opened by breaking the perforation line, the cover flap may be folded downward to reclose the enclosed volume.

In certain aspects, the back panel includes at least one wing flap at an upper corner thereof, at least a portion of the wing flap extending downward below the perforation line. In certain aspects, after the perforation line has been broken, the wing flap may be folded inward to reclose the enclosed volume.

In certain aspects at least portions of the front and back panels are sealed to one another by heat sealing.

In certain aspects, the package includes a paperboard or plastic blister extending through an opening in one of the panels. In certain aspects, the paperboard or plastic blister includes a flange contained within the enclosed volume and not extending through the opening. In certain aspects, at least part of the flange is sealed between the first and second panels.

In another aspect a method is disclosed for making package, the method included providing a front panel having a front top edge, and a front bottom edge, and a pair of front side edges, providing a back panel having a back top edge, a back bottom edge, and a pair of back side edges, each said back side being connected to a side wall that is connected to a side flange, forming a z-fold along each of the back side edges, each z-fold including a portion of the back side edge, a side wall, and a side flange, bringing together the front panel and the back panel so that the each z-fold aligns with a corresponding front side edge; and joining together the front panel top edge, bottom edge, and side edges to the back panel top edge, bottom edge, and side flanges to form an enclosed volume.

In certain aspects of the method, during the bringing together step, the z-folds are held in place by an adhesive. In certain aspects, the adhesive joins the back side edge to the side flange through an opening in the side wall.

In certain aspects, the step of joining together is by heat sealing. In certain aspects, the top, bottom, and side edges are heat sealed together simultaneously. In certain aspects the front and back panels are in a generally flat configuration during the heat sealing. In certain aspects the side edges are heat sealed together before the top and bottom edges. In certain aspects, the back panel is folded into a tent configuration while heat sealing the side edges, and the back panel is in a generally flat configuration during heat sealing the top and bottom edges.

Other aspects of the disclosed package will become apparent from the following description and the accompanying drawings.

### BRIEF DESCRIPTION OF THE DRAWINGS

FIG. 1 is a plan view of a front panel blank for a package;

FIG. 2 is a plan view of a rear panel blank for a package;

FIG. 3A is a perspective view of the blanks of FIGS. 1 and 2;

FIG. 3B is a perspective view of the blanks formed from a single sheet of material;

FIG. 4 is a perspective view of the rear panel blank in a folded configuration;

FIGS. 5A and 5B are perspective views of a blister and product item being assembled with the front panel blank;

FIGS. 6A and 6B are perspective views of a package being assembled;

FIGS. 7A and 7B are perspective views of a top closure flap being positioned

FIGS. 8A-8D are perspective views of various package sealing patterns;

FIG. 9A is a perspective view of a package showing a one-step sealing pattern;

FIGS. 9B and 9C are cross section views of the package of FIG. 9A;

FIG. 9D is a plan view of the package of FIG. 9A;

FIG. 10A is a perspective view of a package showing a first step in a two-step sealing process;

FIG. 10B is a cross section view of the package of FIG. 10A;

FIG. 10C is a plan view of the package of FIG. 10A;

FIG. 10D is a perspective view of the package showing a second step in a two-step sealing process;

FIG. 10E is a cross section view of the package of FIG. 10D;

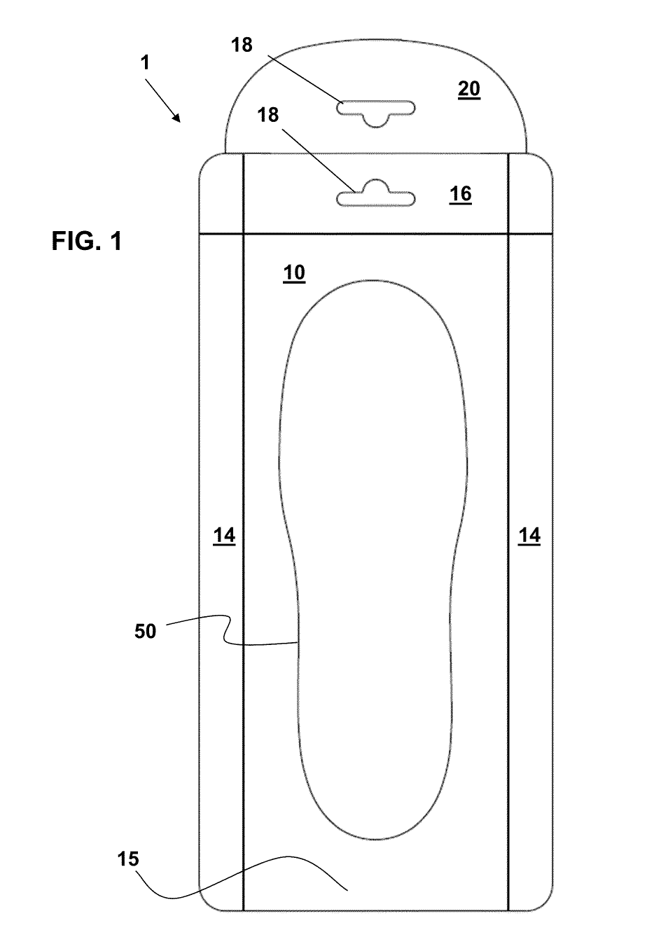

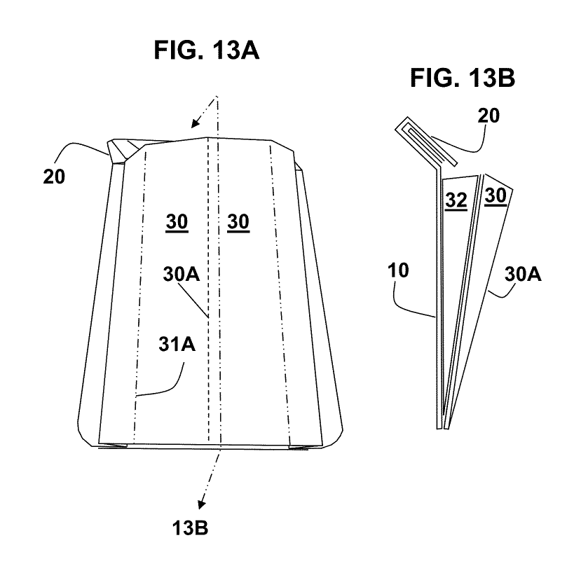

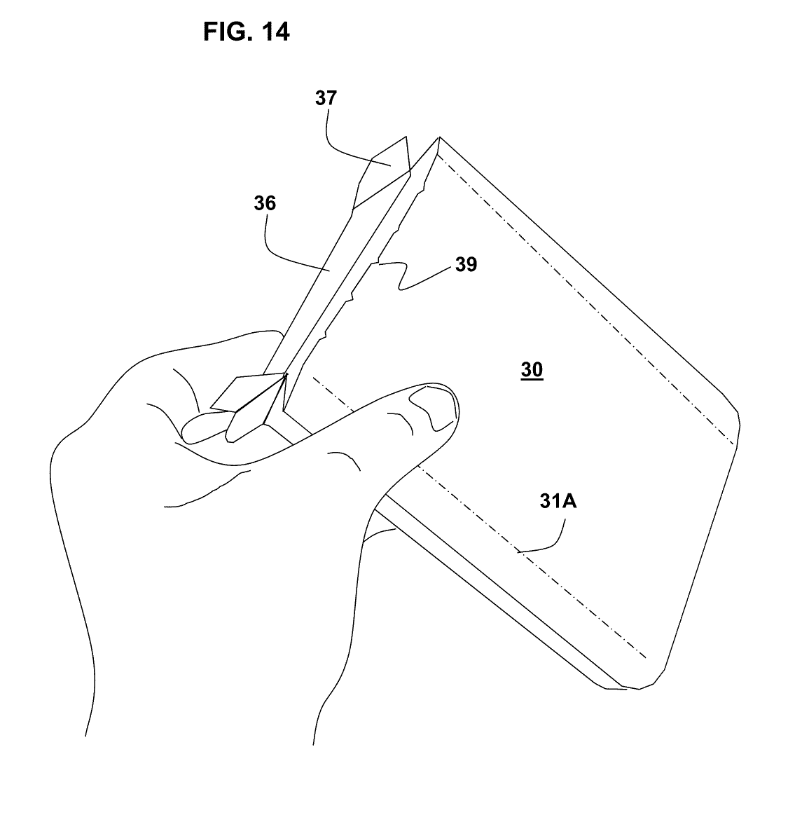

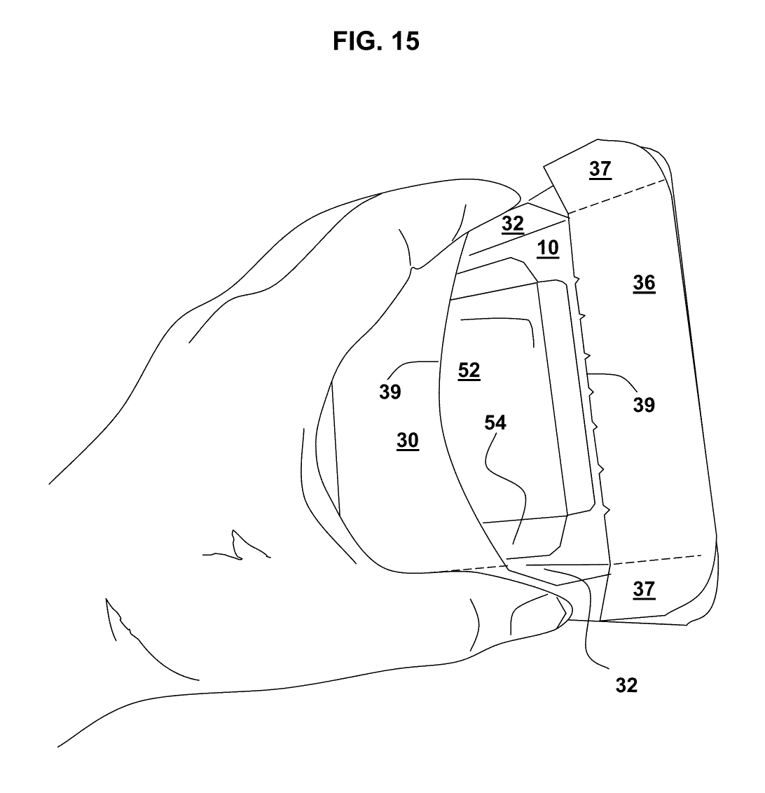

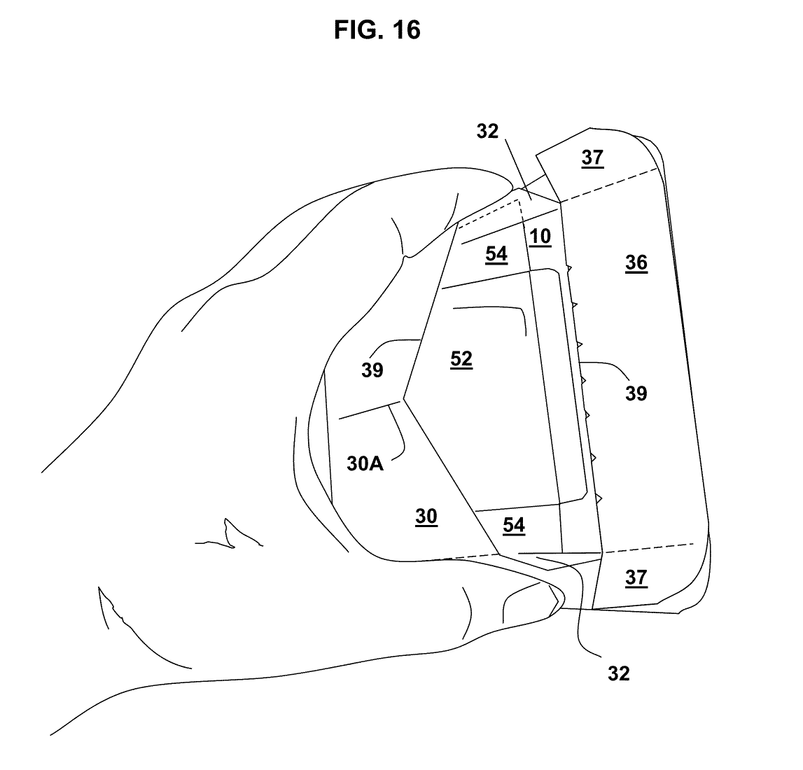

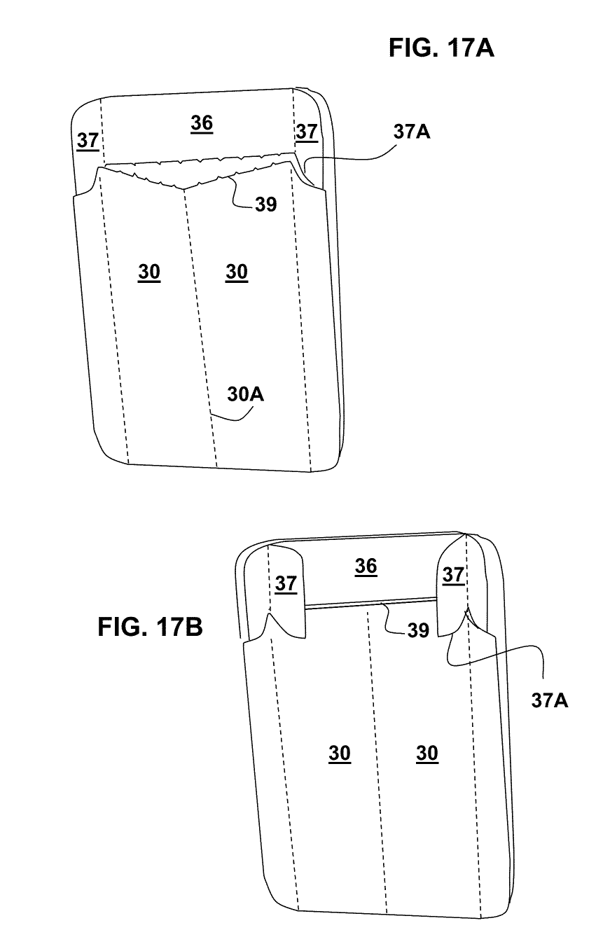

FIG. 1OF is a plan view of the package of FIG. 10D.

FIGS. 11A and 11B are perspective side views of a closed package;

FIGS. 11A and 11B are perspective and side views of an open package;

FIGS. 12A and 12B are perspective and side views of the package opened further;

FIGS. 12C and 12D are perspective and side views of a reclosed package;

FIGS. 13A and 13B are perspective and side views of an alternative package in an open configuration;

FIG. 14 is a perspective view of an open package held in a customer's hand;

FIG. 15 is another perspective view of an open package, showing the interior of the package;

FIG. 16 is a perspective view of another package in an open configuration, showing the interior of the package; and

FIGS. 17A and 17B are perspective views of another package in open and reclosed configurations respectively.

### DETAILED DESCRIPTION

As various embodiments of the package are described, reference will be made to FIGS. 1-17. Certain parts of the packages are denoted by reference numerals. Where there is more than one of the same feature, not all will be necessarily denoted by a reference numeral. Typically in these Figures, where a top plan view is shown for a blank of material, solid lines usually indicate periphery or cuts, and dashed lines usually indicate crease, score, or fold lines. In perspective views, solid lines typically show edges, while dashed lines typically show hidden or partially obscured features, or score lines or potential fold lines that may be flat in the respective view. Where assembly steps are described, these steps are exemplary and are not to be limiting as to the sequence of operations used to arrive at the final package. Also, directions such as up, down, top, bottom, front, back, etc. are used for convenience in describing the package and are not meant to be limiting. In most cases the packages described here are made from two blanks (that is, a front blank and rear blank). However, it should be understood that blanks may be provided instead as more than two parts, or as one part. The word “panel” will often be used to describe a piece of sheet material such as paperboard, particularly with respect to a blank from which the package is made. However, “panel” may also be used to describe a region of a piece of material, for example a portion of the material that is in a first plane, connected across a fold line with the same material in a second plane. Since panels are sometimes superimposed, for example, creating a two-layer structure, like features or panels will sometime coincide, in which cases, descriptions may call out the number identifying the feature closer to the viewer, that is, the feature visible in a particular Figure.

FIG. 1 shows a plan view of a blank 1 for forming a package front panel including a main front face 10. The front panel may include an opening 50 for receiving a blister. The blister may be a plastic or paperboard structure for holding a product. Alternately the opening 50 may be covered by a transparent window, or the opening may be large enough to allow product visibility yet small enough to prevent the product being removed. Alternately the opening 50 may be omitted. If a blister or window is used, it may itself include an aperture through which a customer may view or touch the product.

The front panel may include, on its periphery, side areas 14, lower area 15, and upper area 16. A closure flap 20 may be attached to the upper end 16. The upper end and/or the closure flap may include hang hole 18. A reinforcing layer of paperboard or other material may be placed at the hang hole location, as described in PCT/US08/066517.

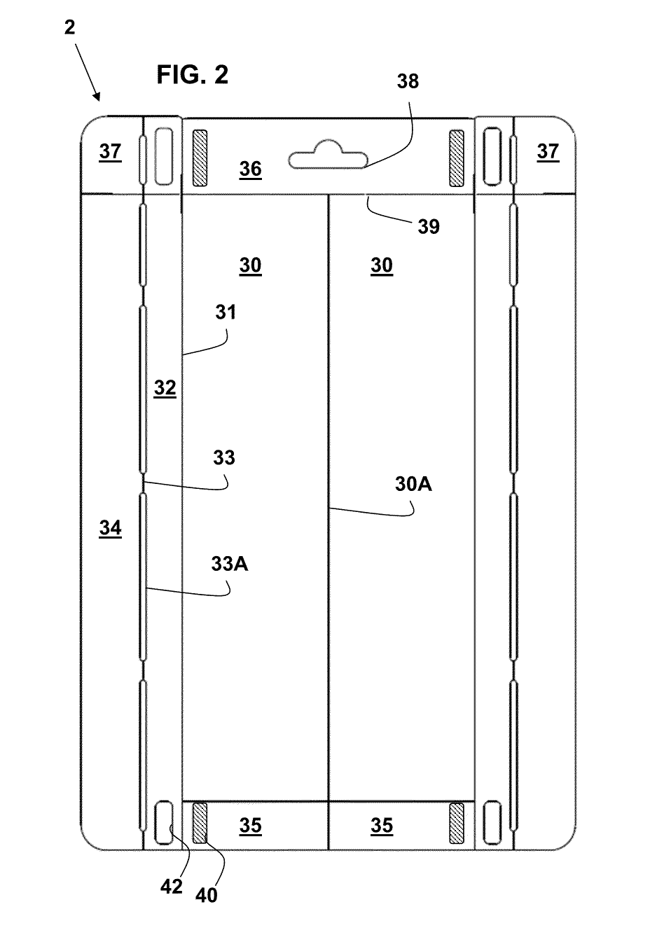

FIG. 2 shows a plan view of a blank 2 for forming a package rear panel including main rear face 30, side walls 32, and side flanges 34 which may be foldably connected by fold lines 31, 33. Relief cuts such as 33A may be provided in the fold lines to enable easier folding; the relief cuts may be scores, perforations, or openings. The rear panel may include, on its periphery, a lower area 35. The rear panel may also include upper area 36 which may be separated from the main rear face 30 by a separation line 39. The upper end area may include hang hole 38. A reinforcing layer of paperboard or other material may be placed at the hang hole location, as described in PCT/US08/066517.

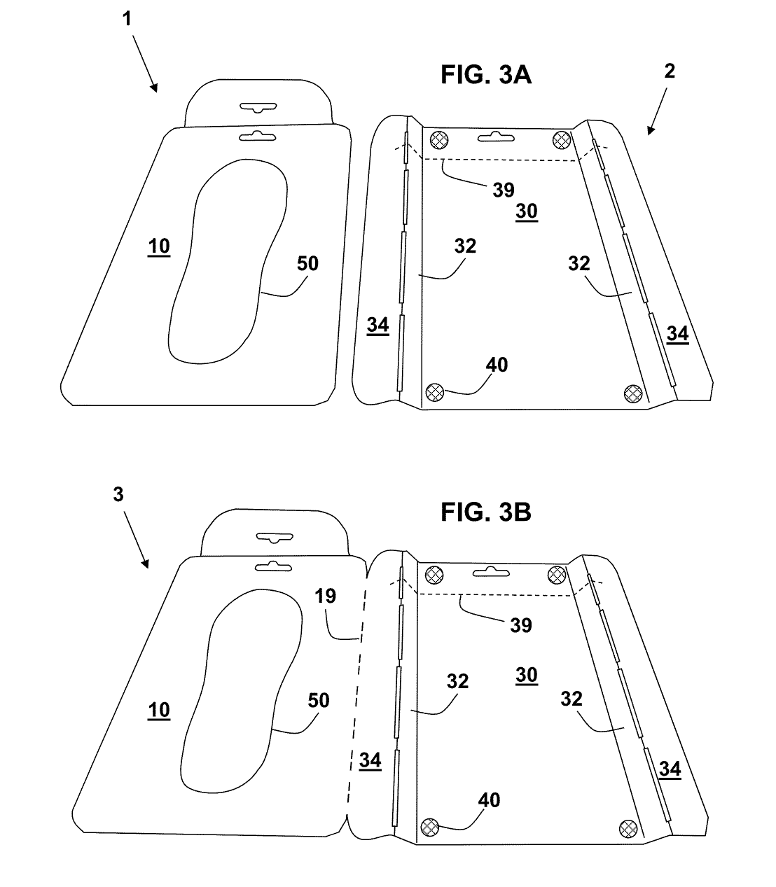

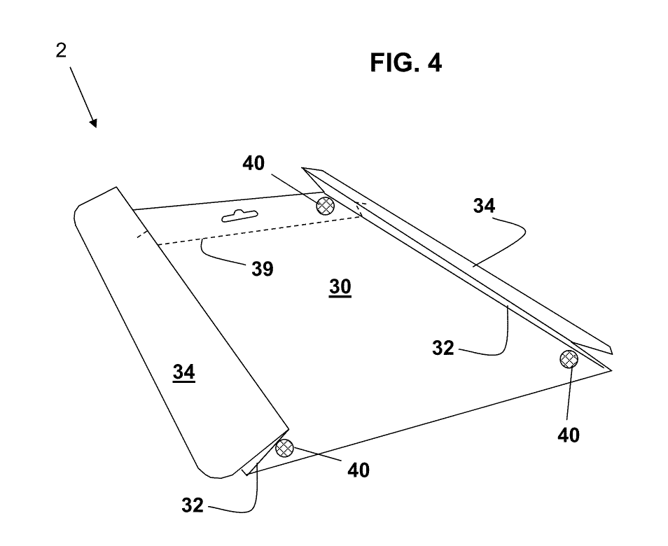

FIG. 3A shows a perspective view of the front blank 1 and back blank 2 in an early stage of assembly. Side walls 32 have been folded relative to main rear face 30, and side flanges 34 folded relative to side walls 32. These folds due to the shape of their final cross-section may be termed “Z folds.” Adhesive 40 may be applied as shown to the ends of the Z folds to secure them during package assembly. Sealing openings 42 may be provided in proximity with the adhesive areas in the intermediate layer of the Z fold, to help join together the different layers of the Z fold. A folder-gluer machine may be used to fold and glue the Z-folds. After the folding-gluing step, the back card may have the same width as the front card. This allows the front and back cards to be aligned with the spring-loaded pins typical in sealing operations. There are other gluing methods that may be used. To relieve pressure on the glued areas, or make it easier to fold the fold lines, the edges of the z folds may be partially cut, or the edge can have long narrow strips 33A of board cut away with periodic land areas. Other methods of creasing or perforation may also be acceptable. The adhesive 40 may be adjusted (by size of adhesive spot, type of adhesive, etc) to hold the Z-fold with a desired amount of strength. For example at the lower corners of the package the adhesive may strongly hold the Z-fold as the lower end of the package may not be expected to open, so the accordion action of the Z-fold is not needed. At the upper end of the package, where the Z-fold may provide for expansion of the opened package, the adhesive may be applied beyond the separation line 39 so as not to inhibit opening the package. At other points along the Z-fold, adhesive 40 may be omitted, or may be applied very lightly (e.g. in a few small spots, or with a weak adhesive) so as to hold the Z-fold during package assembly but release the Z-fold easily during package opening.

As shown in FIG. 3B, a single blank 3 may be used to form the front panel and rear panel, which may be joined for example along a fold line 19 (here shown along a lateral edge, although depending upon the package design, joining along a lower edge or upper edge might be possible in the alternative.

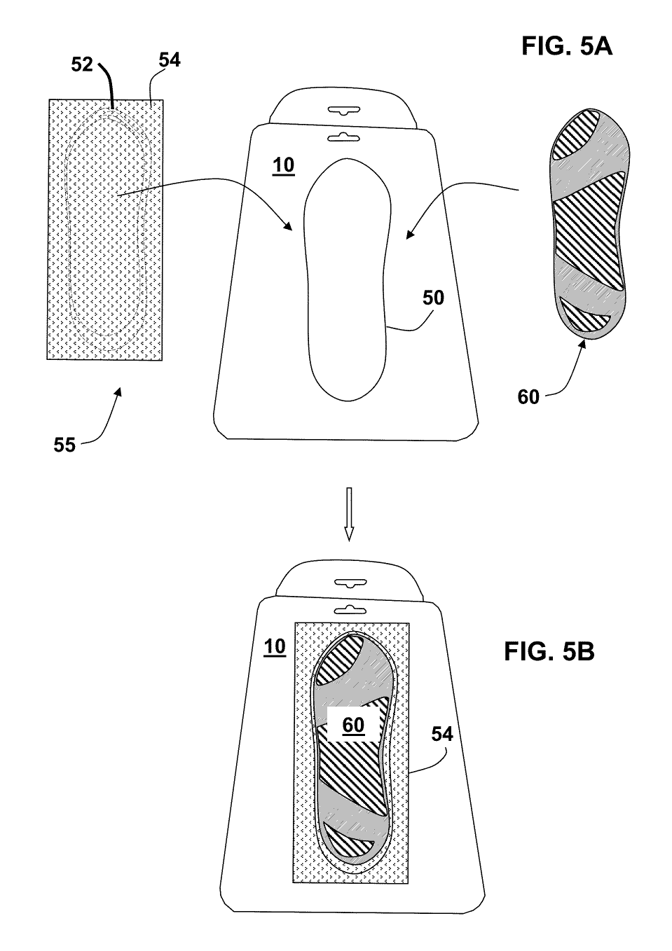

FIG. 4 shows the rear blank 2 in a further stage of folding side walls 32 and side flanges 34 to form Z-folds, which when fully flattened may be held in place by adhesive 40.

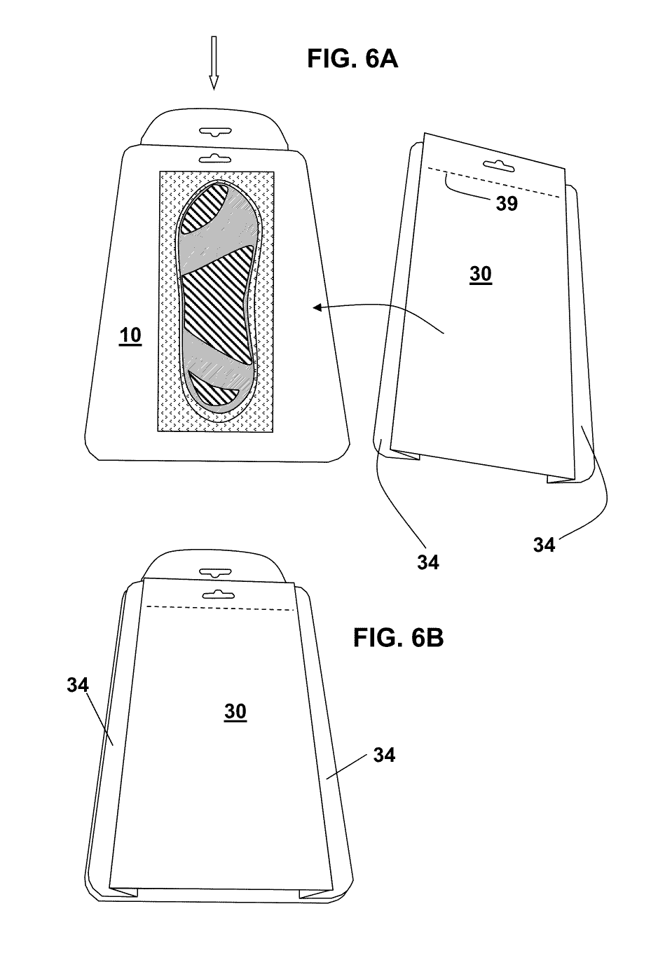

FIG. 5A shows a blister 55 being placed upon back panel 10. The blister may include a cavity 52 which may be placed in register with opening 50 and which may protrude outward, that is toward the back, through opening 50. The blister 55 may also include a blister flange 54 which does not protrude through the opening 50. A product 60 may be placed in the blister cavity 52. The combined rear panel 10, blister with flange 54, and product item 60 are shown in FIG. 5B.

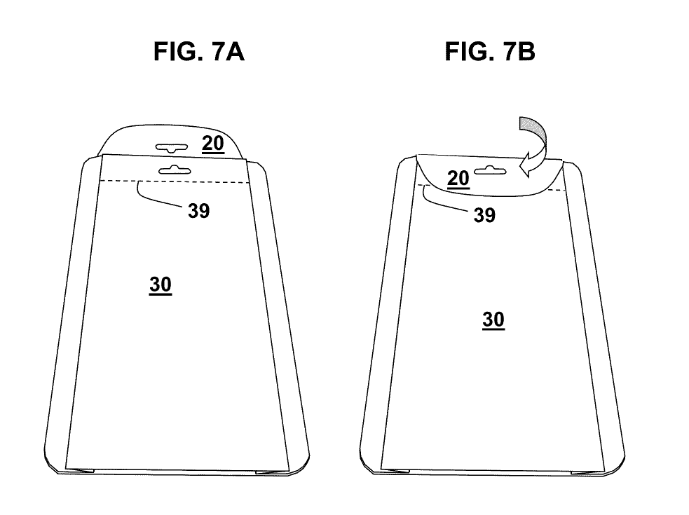

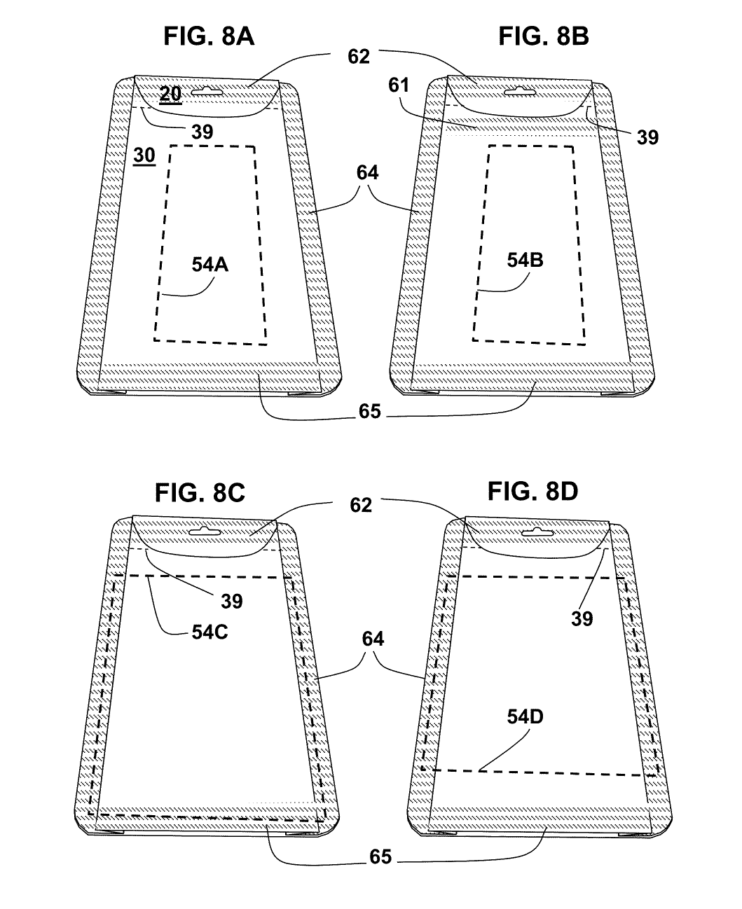

FIG. 6A shows the back panel 30 (inverted from the previous views) being placed upon the front panel 10 so that side flanges 34 are aligned with the side edges of the front panel as shown in FIG. 6B and 7A. FIG. 7B shows how the closure flap 20 attached to the front panel may be folded over onto the back panel 30.

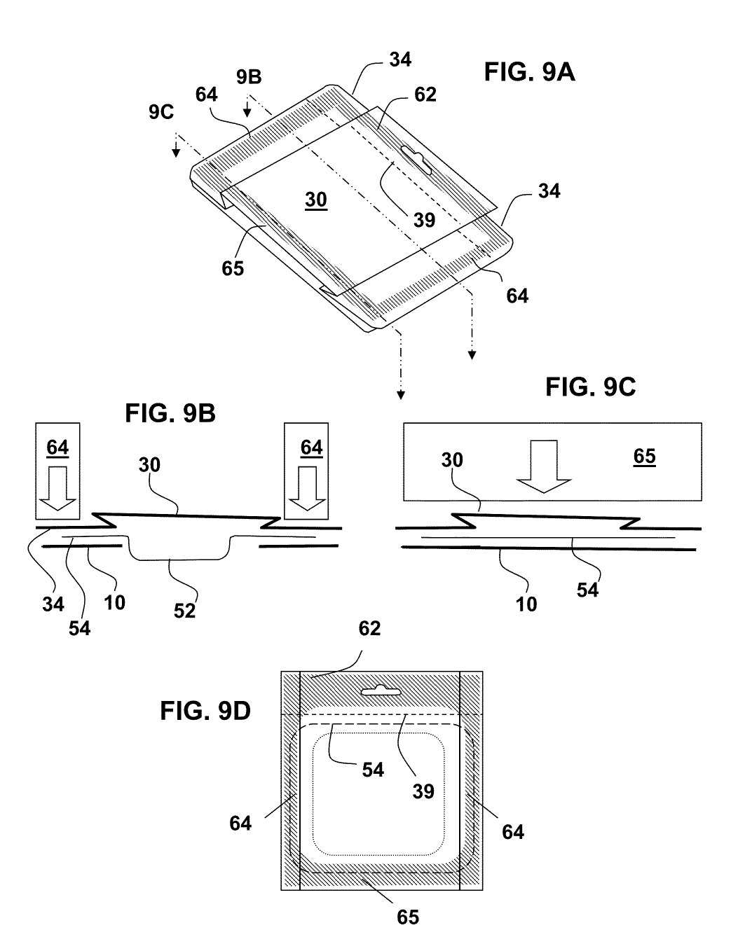

FIGS. 8A-8D show various sealing patterns by which the front and back panels may be sealed together. Sealing may be done by heat sealing, for example if the inner (facing) surfaces of the front and back panels have a heat sealable coating. Sealing may also be done by RF sealing, or other adhesives such as glue, or by mechanical means such as stapling. For example the side edges of the package may be sealed as denoted by sealing patterns 64. The lower edge of the package may be sealed as denoted by sealing patterns 65. The top edge of the package may be sealed as denoted by sealing patterns 62. In this way a pocket or tube shaped cavity may be enclosed between the front and back panels. The upper end of the cavity may however be left unsealed (except for the closure flap 20. Alternatively, the upper end of the cavity may be sealed as shown by upper seal pattern 61.

In each of FIGS. 8A-8D, an outline 54A-54D is shown which represents the blister flange of an optional blister which has already been described. As shown in FIGS. 8A-8B, the blister flanges 54A, 54B may not extend to the area of the sealing patterns 61, 64, 65 and the blister flange may therefore not be sealed by these patterns. As shown by FIG. 8C, the sides and bottom of blister flange 54C may extend into the sealed areas 64, 65 and thus the blister may be sealing attached between the front and back panels. As shown by FIG. 8D, the sides of blister flange 54D may extend into the sealed areas 64 and thus the blister may be sealing attached between the front and back panels. Instead of, or in addition to being sealed by seal patterns 61, 64, 65, the blister flange may be attached by other sealing patterns, or by other means including adhesives, staples, etc. Alternatively, the blister flange may be left unattached to the panels and the blister may be held in place by the blister cavity 52 fitting into opening 50, or by the blister flange fitting more or less closely within the pocket or cavity formed between the front and back panels.

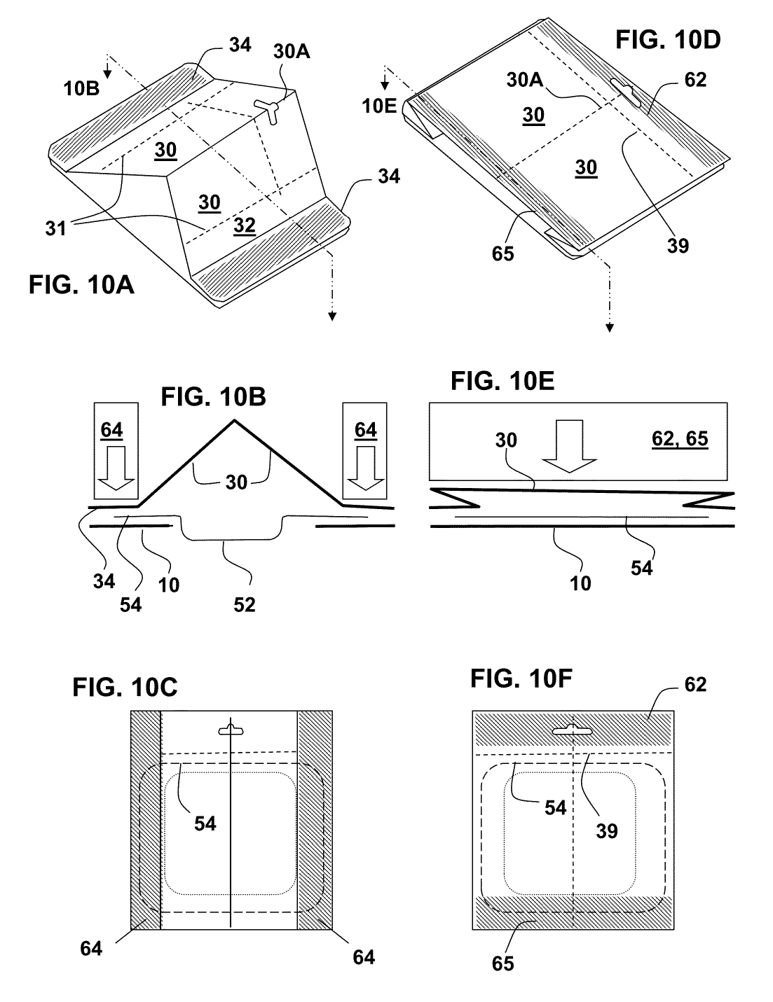

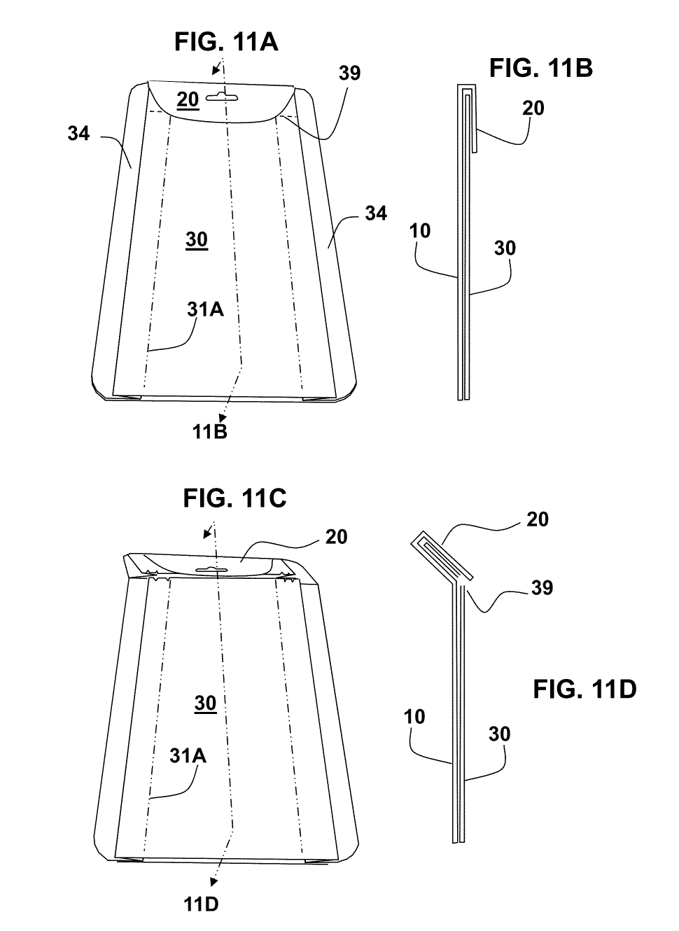

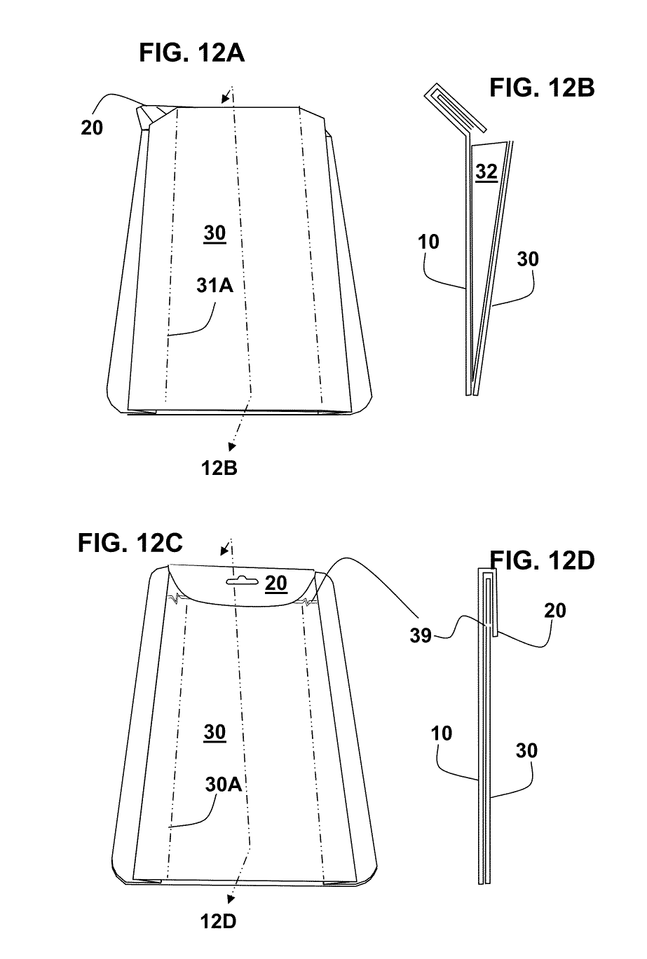

FIGS. 9A-9D show a one-step method for heat sealing together the front panel 10 and back panel 30 after first folding the back panel as shown in FIG. 6A and placing together the front and back panels as shown in FIG. 6B. The panels may be in a generally flat configuration as shown during heat sealing. FIG. 9A shows a heat sealing pattern including side seals 64, lower seal 64, and upper seal 62. Upper seal 62 may be positioned outward (upward) of separation line 39. Cross sectional view lines 9B and 9C are denoted which are illustrated in cross sections as FIGS. 9B and 9C. In FIG. 9B, a cross section of a central part of the package, side sealing tools 64 may apply energy (e.g., heat or other energy) and pressure to seal together front panel 10 with side flanges 34 (and optionally a portion of blister flange 54). In FIG. 9C, a cross section of a lower part of the package, lower end sealing tool 65 may apply energy (e.g., heat or other energy) and pressure to seal together front panel 10 with back panel 30 (and optionally a portion of blister flange 54). The side sealing process (FIG. 9B) and end sealing process (FIG. 9C) may be carried out simultaneously with one or more sealing tools, or sequentially. FIG. 9D shows a plan view of the finished package including side seal areas 64, lower end seal area 65, and upper end seal area 62. The periphery of blister flange 54 is shown to be (optionally) sealed by side seals 64 and lower end seal 65. As shown, the separation line 39 may be left unsealed by top end seal area 62.

A closure flap 20 is not shown in FIGS. 9A-9D. However, a closure flap could be provided and folded over before sealing the top seal area 62.

FIGS. 10A-10F show a two-step method for heat sealing together the front panel 10 and back panel 30 after first folding the back panel in a “tent” configuration as shown in FIG. 10A and placing upon the front panel. FIG. 10A shows a step in heat sealing including providing side seals 64. Cross sectional view line 10B is denoted which is illustrated in cross section as FIG. 10B. In FIG. 10B, a cross section of the package, side sealing tools 64 may apply energy (e.g., heat or other energy) and pressure to seal together front panel 10 with side flanges 34 (and optionally a portion of blister flange 54). FIG. 10C shows a plan view of the package after the side sealing step, including side seal areas 64. Some of the periphery of blister flange 54 is shown to be (optionally) sealed by side seals 64.

FIGS. 10D-10F show a second step after folding the back panel into a “flat” configuration as shown in FIG. 10D. FIG. 10D shows a heat sealing pattern including lower seal 65 and upper seal 62. Upper seal 62 may be positioned outward (upward) of separation line 39. Cross sectional view line 10E is denoted which is illustrated in cross section as FIG. 10E. In FIG. 10E, a cross section of the lower end of the package (a similar section would apply to the upper end), end sealing tools 65 (62 for the upper end) may apply energy (e.g., heat or other energy) and pressure to seal together front panel 10 with back panel 30 (and optionally a portion of blister flange 54). FIG. 1OF shows a plan view of the finished package including side seal areas 64, lower end seal area 65, and upper end seal area 62. The periphery of blister flange 54 is shown to be (optionally) sealed by side seals 64 and lower end seal 65. As shown, the separation line 39 may be left unsealed by top end seal area 62.

A closure flap 20 is not shown in FIGS. 10A-10F. However, a closure flap could be provided and folded over before sealing the top seal area 62. Such a closure flap could, for example, be folded into position after the side sealing is completed but before the upper and lower end sealing is done.

FIG. 11A shows a perspective view of a finished package, while FIG. 11B shows a longitudinal cross section of the same package. A blister is not shown in this package, but could be included. A method to open the package is illustrated in the perspective view of FIG. 11C and the corresponding cross section view of FIG. 11D. The upper end of the package, including closure flap 20, may be bent forward (e.g., toward the front of the package, or toward front panel 10, as shown. This breaks separation line 39 near the upper end of back panel 30, which then allows access into the package. The separation line 39 may be designed according to manufacturing preference with perforations, scores lines, creases, holes, or other weakening methods, based on the thickness and strength of the sheet materials used to form the package, to cause the separation line to separate under a certain amount of force, and/or a certain degree of flex. As continued on FIGS. 12A and 12B, the user is then able to flex the back panel 30 away from the front panel 10, opening a cavity or pocket through which to gain access to the interior of the package, and the contents of blister 55. The Z-Fold side walls previously described may provide a pleated or ‘accordion’ opening action allowing entry into the package. If the lower end of the package is sealed as shown in certain examples herein, the cavity or pocket may assume a wedge shape (being open or wider at the top, and closed or narrow at the bottom).

FIGS. 12C and 12D show how the package, after opening, may be reclosed to a neat appearance essentially the same as an unopened package. The closure flap 20 may extent below the separation line 39. Thus when the back panel 30 is pushed back against the front panel 10, closing the cavity or packet, the closure flap 20 may be bent back to its original position, overlapping the separation line 39 and closing the package.

FIGS. 13A and 13B show an alternative design with one or more additional crease lines 31A that may make it easier to flex open the cavity or pocket.

FIG. 14 shows a side perspective view of an opened package in the hand of a customer. Separation line 39 has been broken by bending upper region 36 toward the front panel (away from the viewer).

FIG. 15 shows a top end perspective view of an opened package in the hand of a customer. Separation line 39 has been broken by bending upper region 36 toward the front panel (away from the viewer). The pleated sides of the package allow it to open, and the customer may further increase the opening by pressing on the sides of the package. A blister is shown inside the package, including a blister cavity 52, and a blister flange 54. In this case the blister flange 54 is shown not sealed between the front and back panels.

FIG. 16 shows a top end perspective view of another opened package in the hand of a customer. Separation line 39 has been broken by bending upper region 36 toward the front panel (away from the viewer). The pleated sides of the package allow it to open, and the customer may further increase the opening by pressing on the sides of the package. A central crease or fold line 30A may be provided in the back panel 30 which may make it easier for the package cavity or pocket to gap open. A blister is shown inside the package, including a blister cavity 52, and a blister flange 54. In this case portions of the blister flange 54 are shown to extend outward to where they are sealed between the front panel 10 and back panel 30 (as shown on FIGS. 8C, 8D, and 9D).

FIG. 17A shows a front perspective view of another package in an opened configuration, and FIG. 17B shows the package in a reclosed configuration. The package may be opened in a manner similar to that already described. Once the separation line 39 is parted, the customer may access the contents of the package. The package may be reclosed after opening by bringing the front and back panels back together (e.g., closing the gap at the separation line 39) and then folding inward the upper wing areas 37 to hold the package closed. To reopen the package, upper wing areas 37 are folded back outward allowing the separation line 39 to reopen. The wing areas may be formed by appropriate cut lines 37A, for example, with these lines sloped or arced downward so that when the wing area 37 is turned inward as in FIG. 17B, its lower edge overlaps the back panels 30 and holds them shut.

The package may be formed of a sheet material such as paperboard, which may be made of or coated with materials to increase its strength. An example of such a sheet material is EASYSEAL paperboard made by MeadWestvaco Corporation. The sheet material may have a heat sealable coating, for example to allow a heat seal to be created between the front panel 10 and back panel 30 as described herein. Alternately, other forms of adhesive may be used to seal these panels together. It should be noted that the use of tear resistant materials, and/or in more than one layer, help to improve the tamper- and theft-resistance of the package.

The package may be used to enclose either a loose item of merchandise, or an inner carton enclosing merchandise. For example, a manufacturer may have an existing well established carton with a well-recognized brand image, but lacking adequate security. Such a carton may have a premium appearance, for example custom graphics, metallization, embossing, or other premium features. By placing the existing premium carton inside package, additional tamper and theft resistance may be provided. Furthermore once the outer package is opened the premium package is still intact. Thus a manufacturer may wish to enclose an existing carton within the package described herein.

The packages disclosed herein may be made from one or several blanks (that is, the cut sheet parts from which the package components are made by folding and other steps). However, it should be understood that certain unitary blanks may be provided instead as more than one part, and certain blanks may be combined into single blanks, while still arriving at the same finished package.

Where more than one blank is used, the blanks may be assembled in various stages, including assembling a unitary blank into a package, assembling separate blanks and then joining them to form a package, and joining two or more blanks together, for example by heat sealing, gluing, mechanical fastening, or otherwise and then forming the combined blanks into the package.

It should be understood that additional foldover panels may be included in the package blanks for further reinforcing the packages.

1. A package comprising:
a front panel having a front top edge, and a front bottom edge, and a pair of front side edges,
a back panel having a back top edge, a back bottom edge, and a pair of back side edges,
said front panel and back panel together forming an enclosed volume with
each of said back side edges being connected through a respective expandable side wall connected to a corresponding front side edge,
said back bottom edge being connected to said front bottom edge, and
said back top edge being connected to said front top edge along an upper region above a closed perforation line across said back panel;
wherein said upper region may be flexed forward relative to said back panel to break said closed perforation line and thereby open said enclosed volume.

2. The package of claim 1, wherein each of said expandable side walls are formed by a z-fold in said back panel.

3. The package of claim 1, wherein at least one of said panels comprises a cover flap foldably attached to the top edge of said panel, and folded downward over said back panel so that the lower periphery of the cover flap extends at least partly beyond said perforation line.

4. The package of claim 3, wherein said cover flap is attached to the upper region of said back panel.

5. The package of claim 3, wherein after the enclosed volume has been opened by breaking said perforation line, the cover flap may be folded downward to reclose said enclosed volume.

6. The package of claim 1, wherein said back panel comprises at least one wing flap at an upper corner thereof, at least a portion of said wing flap extending downward below said perforation line.

7. The package of claim 6, wherein after the perforation line has been broken, the wing flap may be folded inward to reclose said enclosed volume.

8. The package of claim 1, wherein at least portions of the front and back panels are sealed to one another by heat sealing.

9. The package of claim 1, further comprising a paperboard or plastic blister extending through an opening in one of said panels.

10. The package of claim 9, wherein the paperboard or plastic blister comprises a flange contained within said enclosed volume and not extending through said opening.

11. The package of claim 10, wherein at least part of said flange is sealed between said front and back panels.

12. A method for making package, comprising:
providing a front panel having a front top edge, and a front bottom edge, and a pair of front side edges,
providing a back panel having a back top edge, a back bottom edge, and a pair of back side edges, each said back side being connected to a side wall that is connected to a side flange,
forming a z-fold along each of the back side edges, each z-fold comprising a portion of the back side edge, a side wall, and a side flange,
bringing together said front panel and said back panel so that the each z-fold aligns with a corresponding front side edge; and
joining together said front panel top edge, bottom edge, and side edges to said back panel top edge, bottom edge, and side flanges to form an enclosed volume.

13. The method of claim 12, wherein during the bringing together step, the z-folds are held in place by an adhesive.

14. The method of claim 13, wherein the adhesive joins the back side edge to the side flange through an opening in the side wall.

15. The method of claim 12, wherein the step of joining together is by heat sealing.

16. The method of claim 15, wherein the top, bottom, and side edges are heat sealed together simultaneously.

17. The method of claim 16, wherein the front and back panels are in a generally flat configuration during the heat sealing.

18. The method of claim 15, wherein the side edges are heat sealed together before the top and bottom edges.

19. The method of claim 18, wherein the back panel is folded into a tent configuration while heat sealing the side edges, and the back panel is in a generally flat configuration during heat sealing the top and bottom edges.
